(19) United States
(12) Patent Application Publication
(10) Pub. No.: US 2013/0339509 A1
(43) Pub. Date: Dec. 19, 2013

(54) NETWORKING SYSTEMS

(71) Applicant: Yoics, Inc., Palo Alto, CA (US)

(72) Inventors: Michael W. Johnson, Petaluma, CA (US); Ryo Koyama, Palo Alto, CA (US)

(21) Appl. No.: 13/918,773

(22) Filed: Jun. 14, 2013

Related U.S. Application Data
(60) Provisional application No. 61/660,619, filed on Jun. 15, 2012.

(51) Int. Cl. H04L 12/24

(52) U.S. Cl. CPC H04L 41/14
USPC 709/223

(57) ABSTRACT

A system, method, and computer program product are provided for establishing secured connections between trusted users and a plurality of networkable consumer devices In different embodiments, various features may be further incorporated in association with the system, method, and computer program product, for improvement purposes.

### CROSS-REFERENCE TO RELATED APPLICATIONS

This application claims the benefit of U.S. Provisional Patent Application No. 61/660,619, filed Jun. 15, 2012, the entire contents of which are incorporated herein by reference.

If any definitions (e.g. figure reference signs, specialized terms, examples, data, information, etc.) from any related material (e.g. parent application, other related application, material incorporated by reference, material cited, extrinsic reference, etc.) conflict with this application (e.g. abstract, description, summary, claims, etc.) for any purpose (e.g. prosecution, claim support, claim interpretation, claim construction, etc.), then the definitions in this application shall apply.

### BACKGROUND AND FIELD OF THE INVENTION

Embodiments of the present invention generally relate to improvements to networking systems including, but not limited to, networking of consumer devices.

### BRIEF SUMMARY

A system, method, and computer program product are provided for networking consumer devices.

Embodiments of the present invention generally relate to networking systems. In different embodiments, various features may be further incorporated in association with the system, method, and computer program product, for improvement purposes.

### BRIEF DESCRIPTION OF THE SEVERAL VIEWS OF THE DRAWINGS

So that the features of various embodiments of the present invention can be understood, a more detailed description, briefly summarized above, may be had by reference to various embodiments, some of which are illustrated in the accompanying drawings. It is to be noted, however, that the accompanying drawings illustrate only embodiments and are therefore not to be considered limiting of the scope of the invention, for the invention may admit to other effective embodiments. The following detailed description makes reference to the accompanying drawings that are now briefly described.

FIG. 1A shows a system consisting of a virtual device in accordance with one embodiment.

FIG. 1B shows a system comprising a plurality of virtual devices, in accordance with one embodiment.

FIG. 1C shows a system comprising a plurality of consumer devices, in accordance with one embodiment.

FIG. 2A shows a network system comprising a personal published channel, in accordance with one embodiment.

FIG. 2B shows a system containing software for establishing a personal published channel, in accordance with one embodiment.

FIG. 2C shows a method for establishing a personal published channel, in accordance with one embodiment,

FIG. 2D shows a method for establishing a personal published channel, in accordance with one embodiment.

FIG. 3A shows a system comprising a domain map proxy, in accordance with one embodiment.

FIG. 3B shows a method for establishing a domain map proxy, in accordance with one embodiment.

FIG. 3C shows a method for establishing a domain map proxy, in accordance with one embodiment.

FIG. 4A shows a computer system comprising a client, and a device which include a software for establishing a multiple virtual proxy, in accordance with one embodiment.

FIG. 4B shows a method for establishing a for establishing a multiple virtual proxy, in accordance with one embodiment,

FIG. 5 shows a system including an HTTP packet engine, in accordance with one embodiment.

FIG. 6 shows a system comprising an abstract user interface to communicate to a device, in accordance with one embodiment.

FIG. 7 shows the content of a computer program comprising a master database, in accordance with one embodiment.

FIG. 8 shows the contents of a computer program containing device information, in accordance with one embodiment.

While the invention is susceptible to various modifications, combinations, and alternative forms, various embodiments thereof are shown by way of example in the drawings and will herein be described in detail. It should be understood, however, that the accompanying drawings and detailed description are not intended to limit the invention to the particular form disclosed, but on the contrary, the intention is to cover all modifications, combinations, equivalents and alternatives falling within the spirit and scope of the present invention as defined by the relevant claims.

### DETAILED DESCRIPTION

### Conventions

Terms that are special to the field of the invention or specific to this description may, in some circumstances, be defined in this description. Further, the first use of such terms (which may include the definition of that term) may be highlighted in italics just for the convenience of the reader. Similarly, some terms may be capitalized, again just for the convenience of the reader. It should be noted that such use of italics and/or capitalization, by itself, should not be construed as somehow limiting such terms: beyond any given definition, and/or to any specific embodiments disclosed herein, etc.

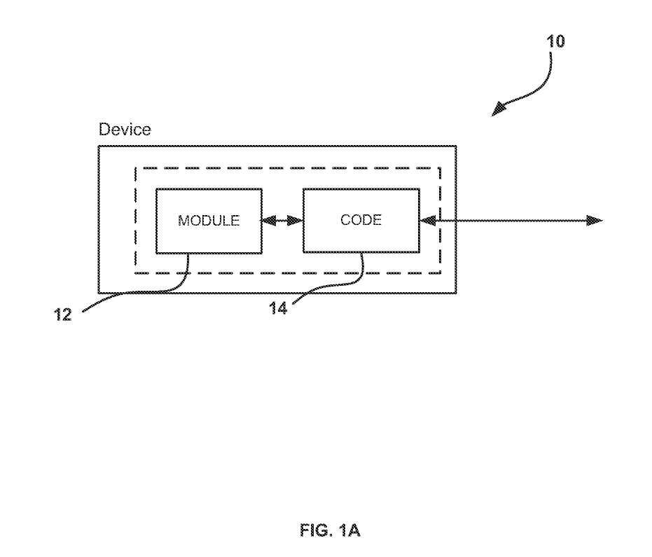

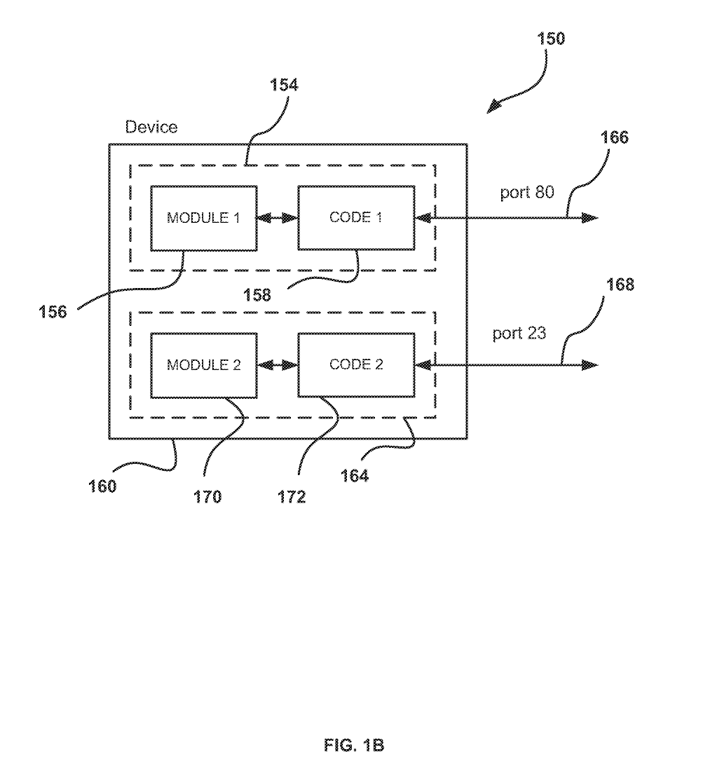

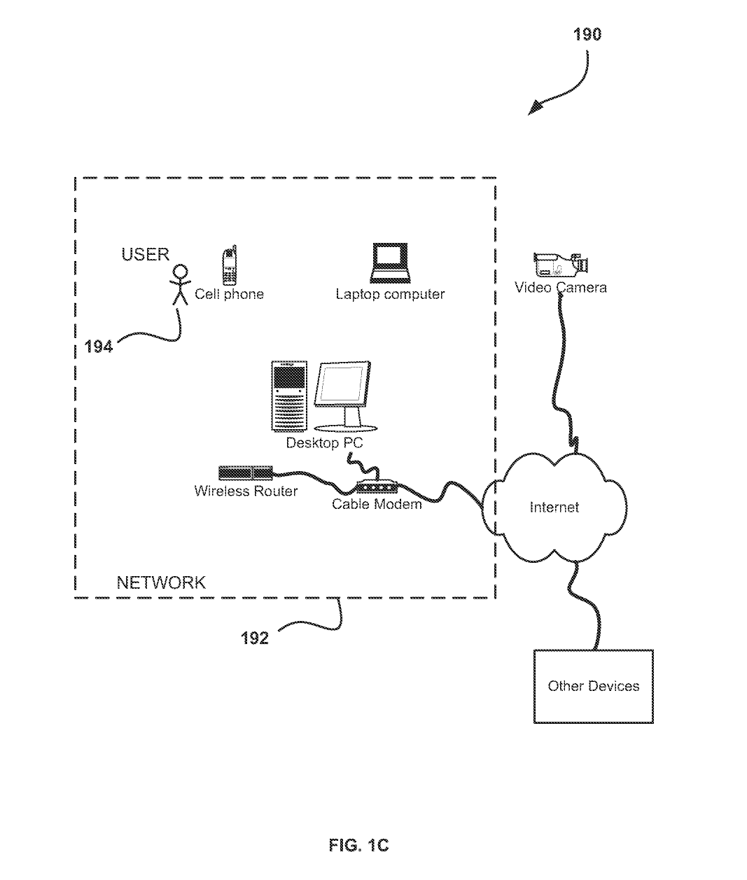

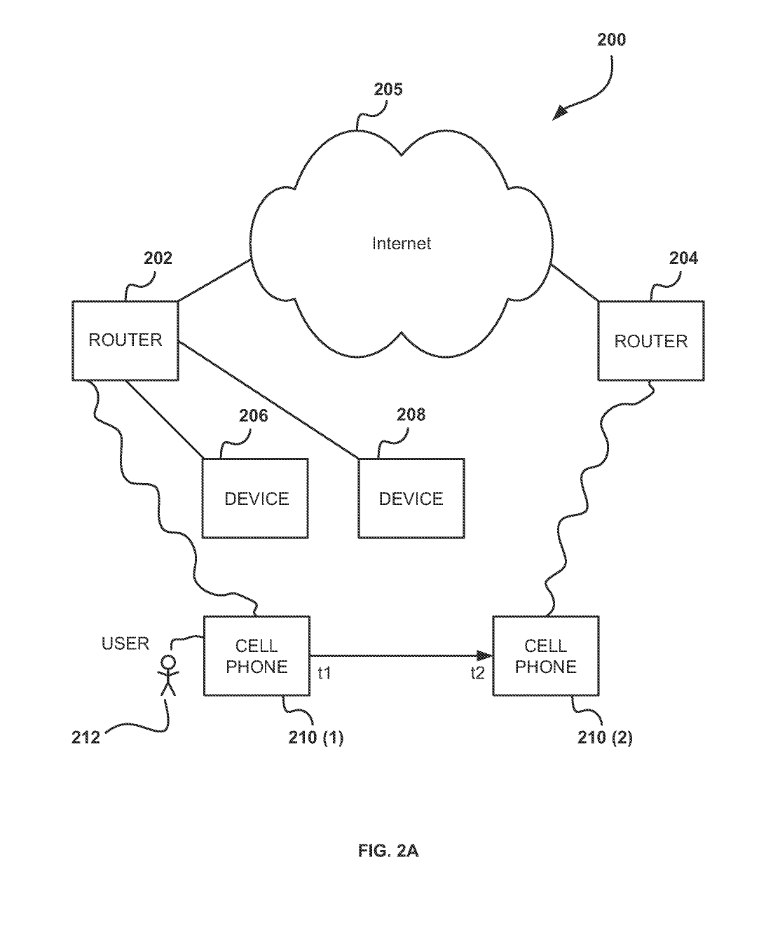

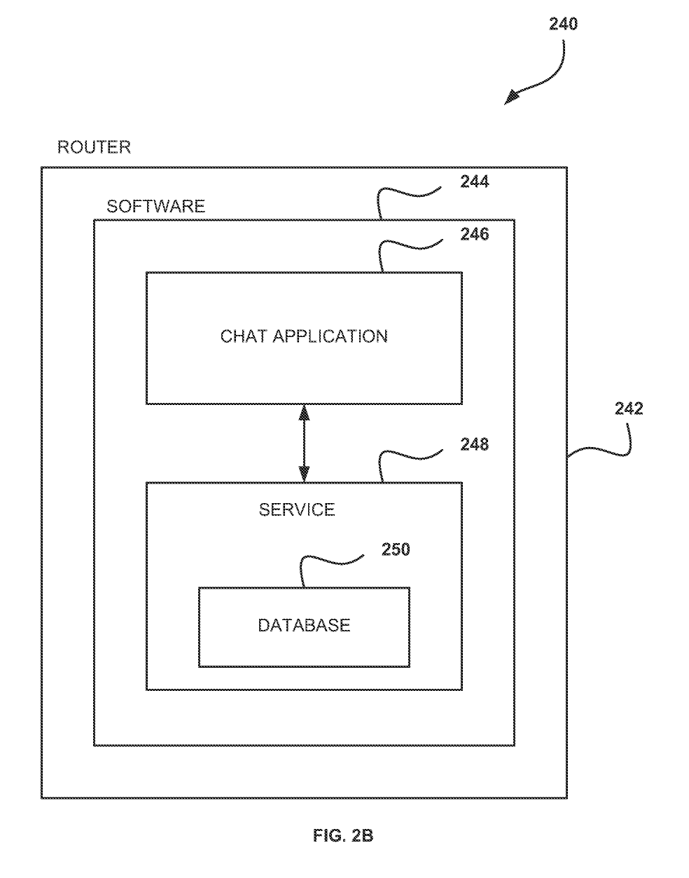

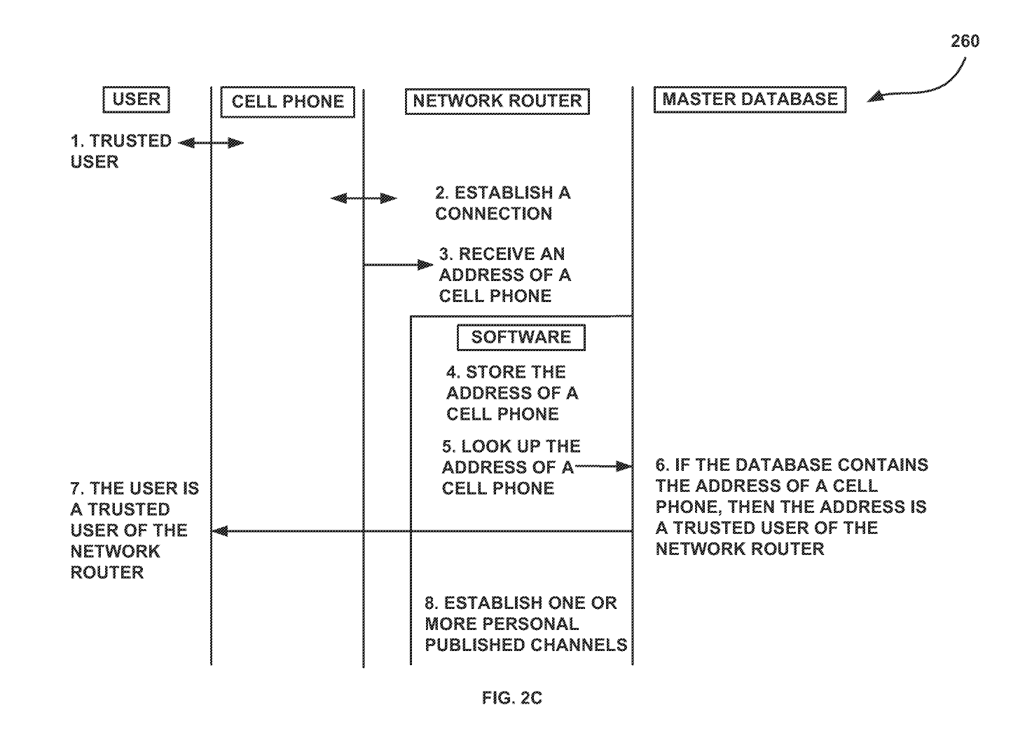

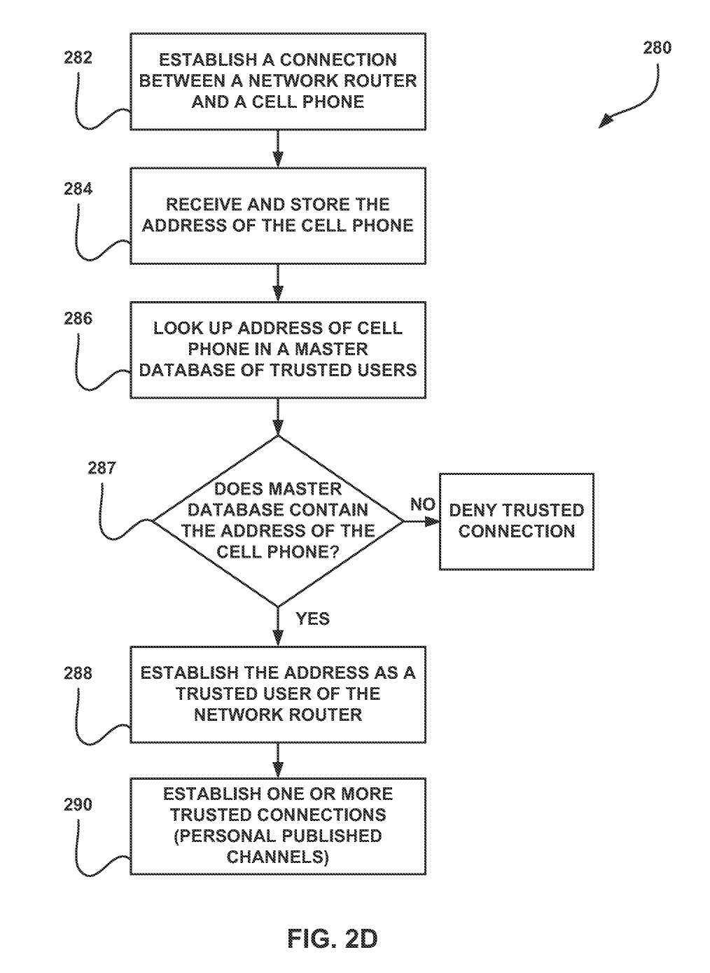

In this description there may be multiple figures that depict similar structures with similar parts or components. Thus, as an example, to avoid confusion an Object in FIG. 1 may be labeled “Object (1)” and a similar, but not identical, Object in FIG. 2 is labeled “Object (2)”, etc. Again, it should be noted that the use of such labels, by itself, should not be construed as somehow limiting such terms: beyond any given definition, and/or to any specific embodiments disclosed herein, etc.

In the following detailed description and in the accompanying drawings, specific terminology and images are used in order to provide a thorough understanding. In some instances, the terminology and images may imply specific details that are not required to practice all embodiments. Similarly, the embodiments described and illustrated are representative and should not be construed as precise representations, as there are prospective variations on what is disclosed that may be obvious to someone with skill in the art. Thus this disclosure is not limited to the specific embodiments described and shown but embraces all prospective variations that fall within its scope. For brevity not all steps may be detailed where such details will be known to someone with skill in the art having benefit of this disclosure.

In the following detailed description and in the accompanying drawings, some embodiments and their constituent parts may have been simplified for clarity of explanation. In some cases a complex system may be broken down into its constituent parts and pieces and each part or piece explained separately. The explanations for each part or piece may possibly use a separate figure along with accompanying text to describe variations and alternative implementations. In some cases complex elements have been simplified to more clearly define their function. In many cases a system may be comprised of multiple complex elements with each element being a more complex version of a simple part or piece that has been explained separately. It is not possible to describe every possible combination of complex elements in all possible systems. Thus this disclosure is not limited to just the specific embodiments of parts or pieces described with each figure or in an accompanying explanation or even those example systems described but rather the possible combinations of complex elements based on the parts and pieces described.

### Definitions

A Uniform Resource Locator (URL) is a Uniform Resource Identifier (URI) that specifies where a known resource is available and the mechanism for retrieving it. A URL consists of the following: the scheme name (also called protocol, e.g. http, https, etc.), colon (“:”), domain name (or IP address), a port number, and the path of the resource to be fetched. The syntax of a URL is scheme://domain:port/path.

The HTTP is the Hypertext Transfer Protocol.

The HTTPS is the Hypertext Transfer Protocol Secure (HTTPS) and is a combination of the HTTP with the SSL/TLS protocol to provide encrypted communication and secure identification.

A session is a sequence of network request-response transactions.

An IP address is a binary number assigned to a device on an IP network e.g. 172.16.254.1 (32-bit dot-decimal notation for IPv4) or 2001:db8:0:1234:0:567:8:1 (128-bit IPv6).

A domain name consists of one or more concatenated labels delimited by dots (periods), e.g. en.wikipedia.org. The domain name en.wikipedia.org includes labels en (the leaf domain), wikipedia (the second-level domain) and org (the top-level domain).

A hostname is a domain name that has at least one IP address. A hostname is used to identify a device (e.g. in an IP network, on the World Wide Web, in an e-mail header, etc.). Note that all hostnames are domain names, but not all domain names are hostnames. For example, both en.wikipedia.org and wikipedia.org are hostnames if they both have IP addresses assigned to them. The domain name xyz.wikipedia.org is not a hostname if it does not have an IP address, but aa.xyz.wikipedia.org is a hostname if it does have an IP address.

The DHCP is the Dynamic Host Configuration Protocol (described in RFC 1531 and RFC 2131) and is an automatic configuration protocol for IP networks. When a DHCP-configured device (DHCP client) connects to a network, the DHCP client sends a broadcast query requesting an IP address from a DHCP server that maintains a pool of IP addresses. The DHCP server assigns the DHCP client an IP address and lease (the length of time the IP address is valid).

A Media Access Control address (MAC address, also Ethernet hardware address (EHA), hardware address, physical address) is a unique identifier (e.g. 00-B0-D0-86-BB-F7) assigned to a network interface (e.g. address of a Network Interface Card (NIC), etc.) for communications on a physical network (e.g. Ethernet).

A trusted path (and thus trusted user, and/or trusted device, etc.) is mechanism that provides confidence that a user is communicating with what the user intended to communicate with, ensuring that attackers cannot intercept or modify the information being communicated.

A proxy server (also proxy) is a server that acts as an intermediary (e.g. gateway, go-between, helper, etc.) for requests from clients seeking resources from other servers. A client connects to the proxy server, requesting a service (e.g. file, connection, web page, or other resource, etc.) available from a different server, the origin server. The proxy server provides the resource by connecting to the origin server and requesting the service on behalf of the client. A proxy server may alter the client request or the server response.

A forward proxy located in an internal network receives requests from users inside an internal network and forwards the requests to the Internet outside the internal network. A forward proxy typically acts a gateway for a client browser (e.g. user, client, etc.) on an internal network and sends HTTP requests on behalf of the client browser to the Internet. The forward proxy protects the internal network by hiding the client IP address by using the forward proxy IP address. The external HTTP server on the Internet sees requests originating from the forward proxy, rather than the client.

A reverse proxy (also origin-side proxy, server-side proxy) located in an internal network receives requests from Internet users outside the internal network and forwards the requests to origin servers in the internal network. Users connect to the reverse proxy and may not be aware of the internal network. A reverse proxy on an internal network typically acts as a gateway to an HTTP server on the internal network by acting as the final IP address for requests from clients that are outside the internal network. A firewall is typically used with the reverse proxy to ensure that only the reverse proxy can access the HTTP servers behind the reverse proxy. The external client see the reverse proxy as the HTTP server.

An open proxy forwards requests to and from anywhere on the Internet.

In network computing, the term de-militarized zone (DMZ, also perimeter network), is used to describe a network (e.g. physical network, logical subnetwork, etc.) exposed to a larger untrusted network (e.g. Internet, cloud, etc.). A DMZ may, for example, expose external services (e.g. of an organization, company, device, etc.). One function of a DMZ is to add an additional layer of security to a local area network (LAN). In the event of an external attack, the attacker only has access to resources (e.g. equipment, server(s), router(s), etc.) in the DMZ.

In the HTTP protocol a redirect is a response (containing header, status code, message body, etc.) to a request (e.g. GET, etc.) that directs a client (e.g. browser, etc.) to go to another location (e.g. site, URL, etc.)

A localhost (RFC 2606) is the hostname given to the address of the loopback interface (also virtual loopback interface, loopback network interface, loopback device, network loopback) i.e. this computer. For example, directing a browser on a computer running an HTTP server to a loopback address (e.g. http://localhost, http://127.0.0.1, etc.) may display the web site of the computer (assuming a web server is running on the computer and is properly configured). Using a loopback address allows connection to any locally hosted network service (e.g. computer game server, or other inter-process communications, etc.).

The localhost hostname corresponds to an IPv4 address in the 127.0.0.0/8 net block i.e. 127.0.0.1 (IPv4, RFC 3330) or ::1 (IPv6, RFC 3513). The most common IP address for the loopback interface is 127.0.0.1 for IPv4, but any address in the range 127.0.0.0 to 127.255.255.255 maps to the loopback device. The routing table of an operating system (OS) may contain an entry so that traffic (e.g. packet, network traffic, IP datagram, etc.) with destination IP address set to a loopback address (the loopback destination address) is routed internally to the loopback interface. In the TCP/IP stack of an OS the loopback interface is typically contained in software (and not connected to any network hardware).

An Internet socket (also network socket or just socket) is an endpoint of a bidirectional inter-process communication (IPC) flow across a network (e.g. IP-based computer network such as the Internet, etc.). The term socket is also used for the application programming interface (API) for the TCP/IP protocol stack. Sockets provide the mechanism to deliver incoming data packets to a process (e.g. application, program, application process, thread, etc.), based on a combination of local (also source) IP address, local port number, remote (also destination) IP address, and remote port number. Each socket is mapped by the OS to a process. A socket address is the combination of an IP address and a port number.

Communication between server and client (which are types of endpoints) may use a socket. Communicating local and remote sockets are socket pairs. A socket pair is described by a unique 4-tuple (e.g. four numbers, four sets of numbers, etc.) of source IP address, destination IP address, source port number, destination port number, i.e. local and remote socket addresses. For TCP, each socket pair is assigned a unique socket number. For UDP, each local socket address is assigned a unique socket number.

A computer program may be described using one or more function calls (e.g. macros, subroutines, routines, processes, etc.) written as function_name ( ), where function_name is the name of the function. The process (e.g. a computer program, etc.) by which a local server establishes a TCP socket may include (but is not limited to) the following steps and functions:

1. socket ( ) creates a new local socket.

2. bind ( ) associates (binds) e.g. links, ties, etc. the local socket with a local socket address i.e. a local port number and IP address (the socket and port are thus bound to a software application running on the server).

3. listen ( ) causes a bound local socket to enter the listen state.

A remote client then establishes connections with the following steps:

1. socket ( ) creates a new remote socket.

2. connect ( ) assigns a free local port number to the remote socket and attempts to establishes a new connection with the local server.

The local server then establishes the new connection with the following step:

1. accept ( ) accepts the request to create a new connection from the remote client.

Client and server may now communicate using send ( ) and receive ( ).

### Terminology

The terminology used herein is for the purpose of describing particular embodiments only and is not intended to be limiting of the invention. As used herein, the singular forms (e.g. a, an, the, etc.) are intended to include the plural forms as well, unless the context clearly indicates otherwise.

The terms comprises and/or comprising, when used in this specification, specify the presence of stated features, integers, steps, operations, elements, and/or components, but do not preclude the presence or addition of one or more other features, integers, steps, operations, elements, components, and/or groups thereof.

In the following description and claims, the terms include and comprise, along with their derivatives, may be used, and are intended to be treated as synonyms for each other.

In the following description and claims, the terms coupled and connected, along with their derivatives, may be used. It should be understood that these terms are not necessarily intended as synonyms for each other. For example, connected may be used to indicate that two or more elements (e.g. circuits, components, logical blocks, hardware, software, firmware, processes, computer programs, etc.) are in direct physical, logical, and/or electrical contact with each other. Further, coupled may be used to indicate that that two or more elements are in direct or indirect physical, electrical and/or logical contact. For example, coupled may be used to indicate that that two or more elements are not in direct contact with each other, but the two or more elements still cooperate or interact with each other.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a circuit, component, module or system. Furthermore, aspects of the present invention may take the form of a computer program product embodied in one or more computer readable medium(s) having computer readable program code embodied thereon.

### FIG. 1A Embodiment

FIG. 1A shows a system 10 consisting of a virtual device, in accordance with one embodiment. As an option, the system 10 may or may not be implemented in the context of the architecture and environment of any subsequent figure(s). Of course, however, the system 10 may be implemented in any desired environment in other embodiments.

As shown, at least one module 12 is included that is characterized as including a first function. In various embodiments, the at least one module 12 may include a hardware and/or software module inclusive of any desired software/hardware code capable of carrying out a variety of functions and/or functionality. For example, the at least one module 12 may include a software service and/or device, etc. associated with a client, router, server (e.g. web server, proxy server, reverse proxy server, etc.). Further, the first function may include any capability, operation, technique, feature, etc. that is capable of being the subject of emulation that will be described hereinafter in greater detail in the context of various embodiments.

Further provided is code 14 for receiving and intercepting communications that are directed to the at least one module 12. In various embodiments, the code 14 may refer to any hardware and/or software code. For instance, in one embodiment, the code 14 may include at least one abstraction layer (e.g. software layer, protocol layer, etc.) in communication with the at least one module 12. Further, in one embodiment, the aforementioned communications may, at one point during communication, be communicated utilizing an Internet Protocol (IP). It should also be noted, however, that the interception may occur before, during, and/or after the communications are communicated utilizing the IP protocol. Just by way of example, in one embodiment, the interception may occur after received IP communications are translated, parsed, etc. into a different format, protocol, etc.

In use, the code 14 serves to modify or create at least one aspect of the communications for emulating a second function that is different from the first function of the at least one module 12. Of course, in various embodiments, such code 14 may only modify the at least one aspect, only create the at least one aspect, and/or any combination thereof (or even a combination thereof with a combination of any other operability).

Further, while such emulation may be carried out for absolutely any desired purpose, various illustrative purposes may involve security-related purposes, communication-protocol purposes, virtual devices, interfaces, GUI, simulation, compatibility, ease of use, trust, payment, etc. In one embodiment, for instance, the aforementioned aspect of the communications to be created and/or modified may involve a level of security. In such embodiment, the above referenced first function may involve a first type of connection and the second function that is emulated may involve a second type of connection. Specifically, the first function may involve a less-secure connection and the second function that is emulated may involve a more-secure connection.

In another embodiment, the at least one aspect of the communications may include a proxy name (e.g. a local host name, etc.). In such embodiment, the first function may involve a first proxy name and the second function may involve a second proxy name. In still yet another embodiment where the communication aspect includes the creation of one or more virtual devices, the first function may involve a physical device without a virtual device and the second function may involve one or more virtual devices in association with the physical device. Even still, another embodiment may involve at least one aspect of the communications that includes a number of endpoints. In such embodiment, the first function may involve an n-way (e.g. 2-way, etc.) communication and the second function that is emulated may involve an m-way (e.g. 3-way, etc.) communication. Further, the first function may involve a first communication protocol and the second function may involve a second communication protocol. Even still yet, another embodiment may involve at least one aspect of the communications that includes creating and/or modifying at least one user interface. For example, in such embodiment, the first function may involve a first user interface and a second function may involve a second user interface that may different from the first user interface in at least one respect.

More illustrative information will now be set forth regarding various optional architectures and features with which the foregoing techniques discussed may or may not be implemented, per the desires of the user. Any of such features may be optionally incorporated with or without the inclusion of other features described.

### FIG. 1B Virtual Devices

FIG. 1B shows a system 150 comprising a plurality of virtual devices, in accordance with one embodiment. As an option, the system 150 may be implemented in the context of any other Figure(s) or accompanying description(s). Of course, however, the system 150 may be implemented in the context of any desired environment.

In FIG. 1B, a device 160 (e.g. cell phone, camera, other consumer electronic device, Internet appliance, media device, etc.) may contain several (e.g. one, two, or more) virtual devices. Each virtual device within a device may appear as a separate device (e.g. a consumer product (e.g. camera, media device, mp3 player, etc.), a service (e.g. telnet, ftp, web server, etc.), combinations of these, or other service/device/product, etc.)

In FIG. 1B, virtual device 154 may contain a module 156 (for example, providing a WWW or world-wide web service in FIG. 1B). In FIG. 1B virtual device 164 may contain a module 170 (for example, a telnet service).

In FIG. 1B, one or more virtual devices may contain an application. In FIG. 1B one or more applications may be any form of embedded firmware and/or hardware and/or software e.g. a chat application; stub; software; other embedded firmware, hardware, software; combinations of these, etc.).

In FIG. 1B, virtual device 154 may contain an application 158. In FIG. 1B virtual device 164 may contain an application 172.

In FIG. 1B, the YOICS application may connect a service (e.g. web server, ftp, telnet, other software module, etc.) and may present (e.g. connect, couple, offer, provide, etc.) the service externally via one or more connections.

In FIG. 1B, virtual device 154 may communicate via connection 166 using port 80. In FIG. 1B, virtual device 164 may communicate via connection 168 using port 23 Note that in FIG. 1B, as well as other figures and throughout this description, specific port numbers and/or other communications means, types, etc. may be used as examples, but any port numbers, etc. may be used.

The use of virtual devices may allow much greater flexibility than the use of conventional devices with services and ports. For example, two virtual devices may be operating on a single device but on the same port. Thus one virtual device may have the address 127.0.0.1:80 and the other virtual device may have the address 127.0.0.2:80. Different web pages may be presented by the two virtual devices. Providing or presenting different web pages from a single device using the same port (port 80) would not be possible without the use of virtual devices.

In one embodiment, one or more virtual devices may contain separate instances (e.g. instantiation, copy, etc.) of the application(s).

In one embodiment, one or more virtual devices may share one or more instance(s) (e.g. instantiation, copy, etc.) of the application(s).

In one embodiment, the application(s) may present one or more services.

In one embodiment, one or more connections may use an IP-based packet network.

In one embodiment, one or more connections may use a non-standard protocol (e.g. chat protocol, etc.).

In one embodiment, one or more virtual devices may use the same connection (e.g. wireless, Wi-Fi, cell network, Ethernet, etc.).

In one embodiment, one or more virtual devices may use a different connection.

In one embodiment, the application(s) may modify (e.g. translate, alter, substitute, encapsulate, change, logically modify, etc.) the service(s) (e.g. protocol, packet format, address, data, number of packets, type of packets, etc.).

### FIG. 1C System of Consumer Devices

FIG. 1C shows a system 190 comprising a plurality of consumer devices, in accordance with one embodiment. As an option, the system 190 may be implemented in the context of any other Figure(s) or accompanying description(s). Of course, however, the system 190 may be implemented in the context of any desired environment.

In FIG. 1C, a plurality of devices may be connected to a network 192 (e.g. home network, LAN, WAN, wireless network, etc.). The connections may be permanent (e.g. fixed, programmed, etc.) or transient (e.g. devices may be moved or moving, may be relocated, may be transferred to different networks, etc.). The devices shown in FIG. 1C are only representative examples of possible devices a user 194 may control (e.g. in the home, at the office, in a car, etc.). The devices shown in FIG. 1C may include devices the user may wish to control (e.g. power on or off, monitor while not at home, otherwise control, etc.). For example, the user 194 may wish to connect to the devices in the network 192 using a separate device (e.g. a cell phone, a computer, a TV, a camera, other appliance, other consumer device, etc.). The systems and methods described in FIG. 1C and subsequent Figures may be used in connection with any device (e.g. networkable consumer device, Internet appliance, home networked device, embedded system, etc.).

In one embodiment, the network 192 may be connected to the Internet.

In one embodiment, additional devices may connect to the network 192.

### FIG. 2A Personal Published Channels

FIG. 2A shows a network system 200 comprising a personal published channel, in accordance with one embodiment. As an option, the network system 200 may be implemented in the context of any other Figure(s) or accompanying description(s). Of course, however, the network system 200 may be implemented in the context of any desired environment.

In FIG. 2A, a network router 202 and a network router 204 may be connected to the Internet 205. Of course any type and number of networks may be used.

In FIG. 2A, the network router 202 may be connected to a device 206 and a device 208. In FIG. 2A a cell phone 210 (1) (or any other mobile device, or other device, etc.) may be connected to the network router 202 at time t1. In FIG. 2A a cell phone 210 (2) may be connected to the network router 204 at time t2. Of course any number of devices and/or any type of devices may be used (e.g. connected, etc.).

In one embodiment, the cell phone 210(1) may not initially be connected to the network router 202. Of course network connections may be made (e.g. established, etc.) and/or broken (e.g. disconnected, etc.) at any time and/or any manner, etc.

FIG. 2A shows a particular network connection of components such as a cell phone 210, a device 206, a device 208 and a network router 202. In different embodiments, other connections of components such as a cell phone 210, a device 206, a device 208 and a network router 202 are possible. Of course any number and type of connections may be used with any number and type of devices, etc.

In one embodiment, the device 206 and the device 208 may be connected to a home network (not shown in FIG. 2A).

As an example, the device 206 and the device 208 may be surveillance cameras. For example, the device 206 may be a surveillance camera inside a house and the device 208 may be one or more surveillance cameras outside the house, etc.

In one embodiment, the device 206 and the device 208 may be any device(s) a user or users may wish to connect to.

In one embodiment, the cell phone 210 may be any device (e.g. a television, Internet appliance, media device (e.g., Google TV, Roku, Apple TV, gaming device, Playstation, Nintendo, etc.), camera, etc.). This list of devices is representative, but not exhaustive, of possible devices which may be connected to a home network or a user or users may otherwise wish to connect to.

In FIG. 2A, a user 212 may initially connect his/her cell phone 210 to a network containing an array of devices including a device 206 and a device 208. At time t1, cell phone 205 (1) may be connected to network router 202. At a later time t2 cell phone 205 (2) may be moved and may now be connected to network router 204. Of course any order of connection or movement of devices, etc. may be used.

In FIG. 2A, the user 212 may be a trusted user of the cell phone 210.

For example, user 212 may be at home at time t1. Network router 202 may be a home router. At time t2, user 212 may move to work. Network router 204 may be at work. User 212 may wish to securely connect to device 206 and device 208 which are at home. User 212 may wish these connections to be trusted connections.

In one embodiment the user may establish one or more trusted connections or personal published channels (e.g. between user 212 and device 206, between user 212 and device 208, between user 212 and device 206 and device 208, between device 206 and device 208, etc.).

As an example, a personal published channel (PPC) may be a media feed (e.g. video feed, music stream, etc.) and device 206 may be a media device (e.g. camera, Roku, media box, Slingbox, streaming media device, AppleTV, Google TV, Netflix, etc.). Of course a PPC may convey (e.g. transmit, receive, communicate, couple, etc.) any type of media, information, data, signals, combinations of these, etc.

In one embodiment, the connection to cell phone 210 may be via any method and/or means (e.g. wireless, Wi-Fi, cell network, Ethernet, dial-up, DSL, optical, magnetic, or any combinations of these and/or other coupling and/or communication means and/or communication methods, etc.).

### FIG. 2B Software for Establishing a Personal Published Channel

FIG. 2B shows a system 240 containing software for establishing a personal published channel, in accordance with one embodiment, As an option, system 240 may be implemented in the context of any other Figure(s) or accompanying description(s). Of course, however, the system 240 may be implemented in the context of any desired environment.

In FIG. 2B, a network router 242 may contain a software 244 that may establish and control PPCs between user(s) and/or device(s) (e.g. user(s) to user(s), user(s) to device(s), device(s) to device(s), etc.).

In FIG. 2B, the software 244 may contain a chat application 246 that communicates with a service 248.

In FIG. 2B, the service 240 may contain a master database 250. The master database 250 may contain a list of addresses of trusted users, other user data, etc.

In one embodiment, the chat application 246 may be any application code.

In one embodiment, the service 248 may be any module (e.g. software, firmware, etc.).

In one embodiment, software 244 may be contained in a router 242 (e.g. wireless router, media box, smart TV, other embedded router function(s), combinations of these, etc.).

In one embodiment, one or more parts (e.g. modules, functions, etc.) of software 244 may be in different locations and/or network components, etc.

In one embodiment, one or more parts of software 244 that perform the function(s) of software 244 may be in software, hardware, firmware, or combinations of these, etc.

### FIG. 2C Method for Establishing a Personal Published Channel

FIG. 2C shows a method 260 for establishing a personal published channel, in accordance with one embodiment, As an option, the method 280 may be implemented in the context of any other Figure(s) or accompanying description(s). Of course, however, the method 280 may be implemented in the context of any desired environment.

As shown in FIG. 2D, a method for establishing a PPC may consist of the following (but not limited to the following) steps.

1. A trusted user of a cell phone C1 (or other mobile device, etc.) seeks to establish a PPC with one or more devices.

2. A network router may establish a connection between the router and a cell phone. This connection may be established, for example, using DHCP.

3. After the connection is established, the network router may receive the address (e.g. MAC address, etc.) of the cell phone.

4. The software contained within the router may store the address of the cell phone.

5. The software may look up (e.g. index, etc.) the address of the cell phone in a master database of trusted users of the router.

6. If the master database contains the address of the cell phone, the software establishes the address of the cell phone as a trusted user of the network router.

7. The preceding steps may establish the address of the cell phone as a trusted user of the network router. Thus the user may be established as a trusted user of the network router via the address of the cell phone.

8. The software may now establish one or more PPCs (e.g. between the trusted user and one or more devices D, for example, as shown in FIG. 2A).

In one embodiment, the address may be any unique ID assigned to a device or virtual device.

In one embodiment, the address may be attached to (e.g. present on a sticker, barcode, label, box, carton, display, etc.) or otherwise associated with the device, device packaging, or portion(s) of the device etc. (e.g. created at point of sale, retrieved during registration, obtained online, etc.).

In one embodiment, cell phone C1 may be any device (e.g. computer, tablet, media player, embedded device, consumer device, appliance, mobile device, fixed device, combinations of these and/or other devices, etc.) or may be one or more devices and/or one or more virtual devices (e.g. a device may present itself as one or more computers, embedded systems, smart TVs, media devices, tablets, software services, etc.).

In one embodiment, the cell phone C1 may have more than one address.

In one embodiment, the method for establishing a PPC may be combined with address mapping. For example, address mapping may use IPv4 to IPv6 mapping and/or use private IP addresses on a router. For example, cell phone C1 may be connected using a router R1 (e.g. a home router, etc.). Assume router R1 supports PPCs. For example cell phone C1 may have a PPC mapped to (e.g. paired with, associated with, linked to, etc.) a first address A1 (e.g. A1 may be an IPv4 address such as 10.10.10.99:5959, a loopback address, combinations of these and/or other addresses, etc.) using a router R1. For example, the mapping may be static (e.g. fixed, programmed, set, etc.) or may be dynamic (e.g. configurable, etc.). Thus, for example, when cell phone C1 uses the first address A1 (e.g. 10.10.10.99:5959, etc.) the router R1 may translate (e.g. map, etc.) the address A1 to a second address A2 (e.g. a private address, an IPv6 address, a loopback address, combinations of these and/or other addresses, etc.) associated with a device D1. For example, D1 may be a security camera, another mobile device, a service, etc. Then, cell phone C1 may move or otherwise change connection to router R2. Assume router R2 supports PPCs. Cell phone C1 may use the first address A1 (e.g. 10.10.10.99:5959) to access D1 and router R2 may automatically connect the cell phone C1 with the security camera D1 using the second address A2.

In one embodiment, more than one device may be mapped. In one embodiment, one address may be translated to multiple devices. For example, two devices D1 and D2 may use a first address A1 (e.g. 10.10.10.99:5959) as their mapping. When a first mobile device, e.g. cell phone C1, connects to a first address A1, a first router R1 may translate the first address A1 to a second address A2 (the second address A2 may be associated with a first device D1). For example, A2 and D1 may belong to a first security camera, etc. When a second mobile device, e.g. cell phone C2, connects to the first address A1, a second router R2 may translate the first address A1 to a third address A3 (the third address A3 may be associated with a second device D2). For example A3 and D2 may belong to a second security camera, etc. Of course R1 and R2 may be the same router. Of course any number of devices (e.g. D1, D2) may be mapped. Of course any number and type of addresses (e.g. A1) may be mapped. The translation of addresses (e.g. A1 to A2) may be fixed (e.g. programmed, etc.) or dynamic (e.g. programmable, configurable, etc.). Of course any type of mobile device (e.g. C1, C2) may be used. Of course any types of devices (C1, C2, mobile, fixed, etc.) may be used to connect. Of course any types of devices (D1, D2, mobile, fixed, etc.) may be connected.

### FIG. 2D Method for establishing a Personal Published Channel

FIG. 2D shows a method 280 for establishing a personal published channel, in accordance with one embodiment, As an option, the method 280 may be implemented in the context of any other Figure(s) or accompanying description(s). Of course, however, the method 280 may be implemented in the context of any desired environment.

As shown in FIG. 2D, a network router establishes a connection between the router and a cell phone. See operation 282. This connection may be established, for example, using DHCP.

After the connection is established, the network router may receive the address (e.g. MAC address, etc.) of the cell phone. See operation 284.

The software contained within the router next may store the address of the cell phone. See operation 284.

The software next may look up (e.g. index, retrieve, etc.) the address of the cell phone in a master database. See operation 286.

If the master database contains the address of the cell phone (see decision 287), the software may next establish the address of the cell phone as a trusted user of the network router. See operation 288.

The cell phone user is a trusted user of the cell phone, and the cell phone is a trusted user of the address of the cell phone. Operations 282. 284, 286, 287 and 288 may establish the address of the cell phone as a trusted user of the network router. Thus the user may be established as a trusted user of the network router via the address of the cell phone.

The software may now establish one or more PPCs (e.g. between the trusted user and one or more devices, for example, as shown in FIG. 2A).

In one embodiment, an address may be any unique ID assigned to a device or virtual device.

In one embodiment an address may be attached to (e.g. present on a sticker, barcode, label, box, carton, display, etc.) or otherwise associated with the device, device packaging, or portion(s) of the device etc. (e.g. created at point of sale, retrieved during registration, obtained online, etc.).

In one embodiment cell phone C1 may be any device (e.g. computer, tablet, media player, embedded device, consumer device, appliance, etc.) or may be one or more devices and/or one or more virtual devices (e.g. a device may present itself as one or more computers, embedded systems, smart TVs, media devices, tablets, software services, etc.).

In one embodiment cell phone C1 may have more than one address.

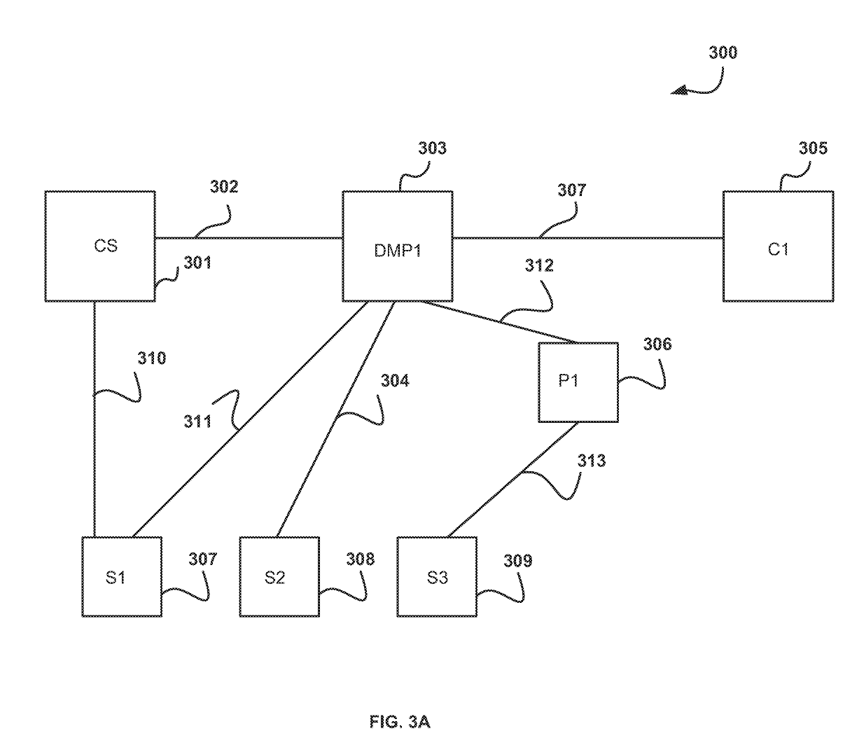

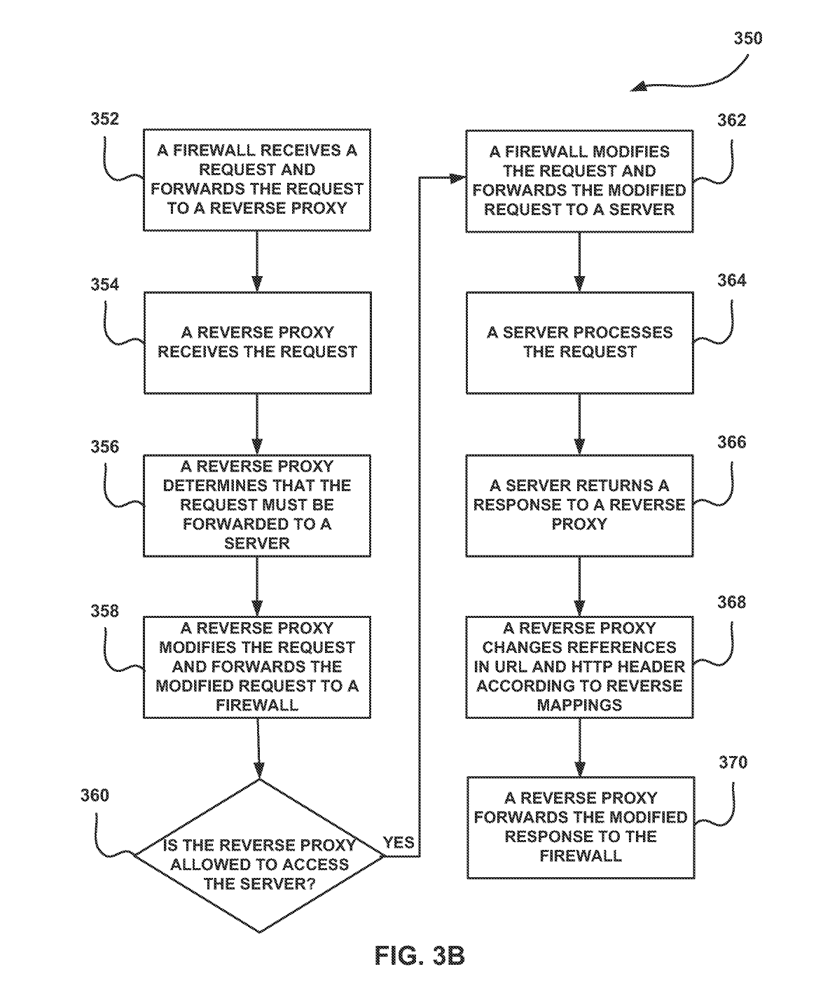

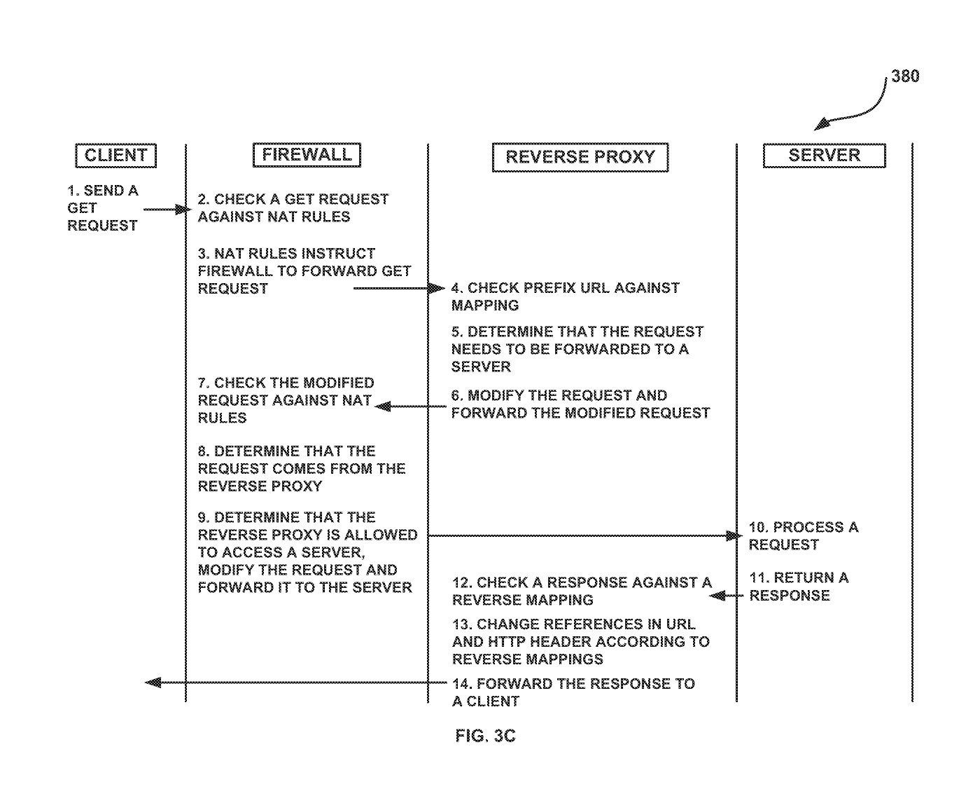

### FIG. 3A Direct Map Proxy

FIG. 3A shows a system 300 comprising a direct map proxy, in accordance with one embodiment. As an option, the system 300 may be implemented in the context of any other Figure(s) or accompanying description(s). Of course, however, the system 300 may be implemented in the context of any desired environment.

FIG. 3A comprises the following internet devices: a connection service (e.g. peer-to-peer connection service, P2P connection service, YOICS connection service, etc.) CS 301, a direct map (DM) proxy DMP1 303, a client 305 (e.g. YOICS user, etc.), servers S1 307, server S2 308, server S3 309, proxy P1, 306. In FIG. 3A the Internet devices may be connected using Internet connections 302, 304, 307, 310, 311, 312, 313.

In a first embodiment the DM proxy DMP1 may establish a direct mapped connection between a client and a server using a map. For example, in FIG. 3A, client C1 may connect to the DM proxy DMP1 using domain name xxx.proxy.com using an Internet connection 307. The DM proxy DMP1 may use the map (e.g. internal software table, etc.) to map the domain name xxx.proxy.com to domain name xyz.com. Server S2 may host domain xyz.com. Server S2 may be connected to DMP1 via direct connection 304. Server S2 may be an IP camera, for example.

In a second embodiment the DM proxy DMP1 may establish a direct mapped connection between a client and a server using a connection service. For example, in FIG. 3A, client C1 may connect to the connection service CS (e.g. YOICS service, etc.) at www.yoics.com through DMP1 using Internet connections 307 and 302. For example, client C1 may login to www.yoics.com with a user name and password and request a connection (e.g. using a web page hosted by CS, etc.) to an Internet camera named myipcamera1. The Internet camera myipcamera1 may be located at server S1. The connection service CS may then setup a connection between client C1 and server S1 as described in the following steps. The connection service CS may, in a first step, lookup myipcamera1 and discover the association of myipcmaera1 with server S1. The connection service CS may, in a second step, connect to server S1 via Internet connection 310. The connection service CS may, in a third step, using Internet connection 310 initiate a P2P connection, a myipcamera1 connection, between server S1 and client C1. The myipcamera1 connection between C1 and S1 may be initiated in a first stage using Internet connection 310, 302 and 307, but may transition in a second stage to Internet connections 311 and 307. The connection service CS may, in a fourth step, assign a domain name 943216.com to the myipcamera1 connection, for example. The assigned domain name may be dynamic or static, for example. The assigned domain name may be randomly chosen, for example. The connection service CS may, in a fifth step, send the domain name to DMP1. As part of the myipcamera1 connection the domain name 943216.com is sent to the client.

In a third embodiment the DM proxy DMP1 may establish a direct mapped connection between a client and a server using a connection service and an indirect link. For example, in FIG. 3A, client C1 may connect to the connection service CS (e.g. YOICS service, etc.) at www.yoics.com through DMP1 using Internet connections 307 and 302. For example, client C1 may login to www.yoics.com with a user name and password and request a connection (e.g. using a web page hosted by CS, etc.) to an Internet camera named myipcamera2. The Internet camera named myipcamera2 may be located at server S3, for example. A connection, myipcamera2 connection, may be established as described for the myipcamera1 connection, but the connection between server S3 and DMP1 may be an indirect connection. For example P1 may be another proxy (e.g. DMP1 and P1 may form a nested proxy, etc.). For example P1 may be a tunnel (or other indirect network link, etc.).

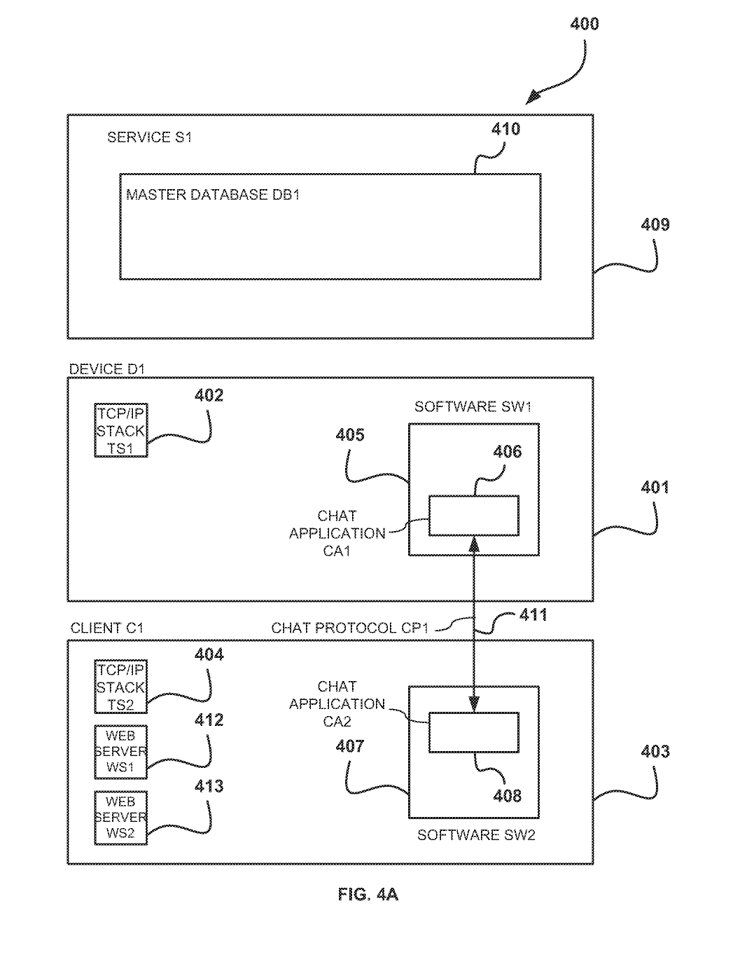

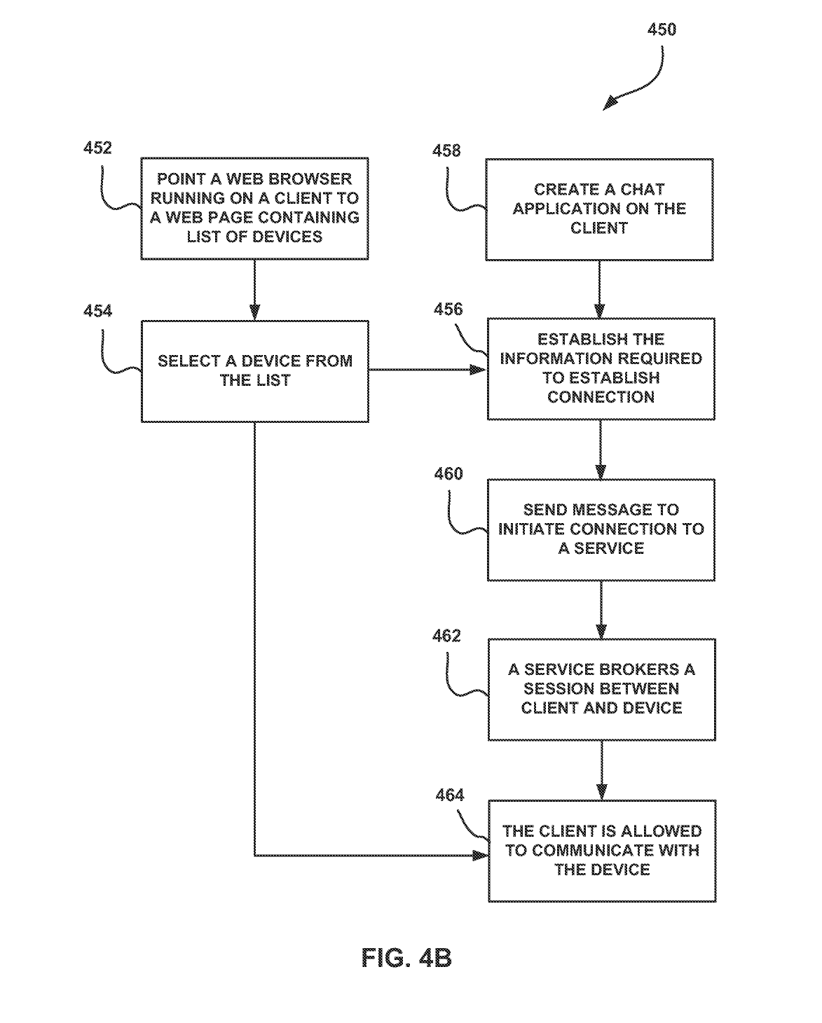

### FIG. 4A Multiple Virtual Proxy

FIG. 4A shows a computer system 400 comprising a client, and a device which include a software for establishing a multiple virtual proxy, in accordance with one embodiment. As an option, the computer system 400 may be implemented in the context of any other Figure(s) or accompanying description(s). Of course, however, the computer system 400 may be implemented in the context of any desired environment.

In FIG. 4A, a device 401 may contain a TCP/IP stack 402.

In FIG. 4A, a client 403 may contain a TCP/IP stack 404.

In FIG. 4A, a device 401 may contain a software 405 and a chat application 406.

In FIG. 4A, a client 403 may contain software 407 that may create a chat application 408.

In FIG. 4A, a user (not shown) using client 403 may connect to device 401

In FIG. 4A, a service 409 (also server, chat server) may maintain a master database 410 of users, devices and clients including connection information required to establish connection(s) between devices(s) and client(s).

In FIG. 4A, a client 403 and a device 401 may communicate via a chat protocol 411 e.g. the chat protocol may appear to use UDP/IP and/or TCP/IP and/or other protocols, etc. over Ethernet, other network(s), etc, but the connection (e.g. chat protocol connection) may be via LAN, WAN, etc; may be wired, wireless, or combinations of these and other media, etc; may use any protocol(s) or combination of protocol(s), etc, or any other form of connection that allows communication between end points (e.g. devices, clients, computers, etc.).

In FIG. 4A, the service 409 and the chat applications 406 and 408 act as a multiple virtual proxy.

In one embodiment, the service 409 may be a server (e.g. web server, computer, cloud server, etc.).

In one embodiment, the service 409 may run on (e.g. execute, operate, etc.) one or more servers (e.g. web server, computer, cloud server, etc.).

In one embodiment, the function of the service 409 may be distributed and one or more parts of the service 409 (e.g. portions, modules, functions, etc.) may be running on (e.g. executing, operating, etc.) one or more components (e.g. servers, embedded devices, cloud services, hardware, etc.).

In one embodiment, one or more functions performed by the service 409 may be preset (e.g. preconfigured, programmed, automated, etc.) such that one or more portions (e.g. parts, functions, operations, etc.) described in other embodiments may or may not be required as described.

In one embodiment, the service 409 may pass private address (e.g. internal network address, internal IP address, etc.) and public address (e.g. external network address, external IP address, etc.) information (e.g. of a device 401, etc.) to one or more clients (e.g. a client 403, etc.).

In one embodiment, a user (not shown in FIG. 4A) may use an address directly as the connect side address (e.g. by entering an IP address possibly with port number etc. into a browser running on the client 403, by using telnet, etc.).

In one embodiment, a user may use a loopback address (e.g. IP address 127.0.0.1, etc.) as the connect side address.

Any traffic sent (e.g. by a computer program, process, etc.) to the loopback interface is immediately received and processed on the same interface. Any traffic with a source address or destination address set to a loopback address must not appear outside of a computer system or be routed. Any traffic with a loopback destination address that is received on an interface must be dropped. Thus if the connect side address is a loopback address we know that the connection is secure (e.g. can only originate from the computer running the browser used to connect, etc.).

Thus, for example, if the connect side address is 172.18.7.170:80, the connection may or may not be secure, and should be treated as unsecure initially. If, for example, the connect side address is 127.0.0.1:80 then the connection is known to be secure

In one embodiment, if the connection uses a loopback address then the connection (e.g. between client and device, etc.) may treated differently (e.g. may be given a different security treatment, may be given a different UI etc.).

A port number is a 15-bit unsigned integer. Port numbers range from 1 to (2̂16)−1 or 65535. A registered port is a port assigned by the Internet Corporation for Assigned Names and Numbers (ICANN). A registered port is a port with a port number in the range 1024-49151. Ports with port numbers less than 1024 are called well-known ports. Ports with port numbers greater than 49151 are called dynamic ports (also private ports).

Note that the IPv4 loopback address block is a single class A block, written as 127.0.0.0/8 with netmask 255.0.0.0. There are 16,777,216 loopback addresses in a 24-bit block with addresses from 127.0.0.0 to 127.255.255.255.

Note that for each of the 16,777,216 loopback addresses (e.g. 127.a.b.c, etc.) used as a connect side address there are 65535 possible ports available for different devices, different UIs, or otherwise different treatments (e.g. facets, views, etc.) of end points (e.g. devices, clients, other computers, etc.).

### FIG. 4B Method for Establishing a Multiple Virtual Proxy

FIG. 4B shows a method 450 for establishing a for establishing a multiple virtual proxy, in accordance with one embodiment, As an option, the method 450 may be implemented in the context of any other Figure(s) or accompanying description(s). Of course, however, the method 450 may be implemented in the context of any desired environment.

In FIG. 4B, communication may be established between a device D1 and a client C1 in the two following steps. Step 0 is the Setup and Step 1 is the Connection.

Step 0: Setup may establish the connection information (e.g. IP addresses, ports, etc.) as well as credentials etc. required. See operation 456.

Step 1: Connection may be performed with the following steps:

Step 2: User U1 may point (e.g. enter information on a keyboard, etc.) a web browser WB1 (or other application program, etc.) running on client C1 to a web page (e.g. at yoics.com and a pre-assigned page, or directed to a specific web page via login/username/password, etc.). See operation 452.

Step 3: User U1 may see a list of devices L1 including device D1 (D1 may be a camera for example). See also operation 452.

Step 4: User U1 may initiate a connection to device D1 by selecting device D1 from L1 (or otherwise choosing one or more device, etc.). See operation 454.

Step 5: Application Y2 may create a chat application CA2 (or CA2 may already be running, etc.). See operation 458.

CA2 already has information established, for example, by Step 0: Setup required to connect to device D1. This information may be used in operation 456.

Step 6: CA2 on C1 may initiate the connection to device D1 by sending, for example, a message “C1 wishes to connect to D1” to the service, YS1. See operation 460.

Step 7: The service YS1 may broker a session between client C1 and device D1 by passing connection information to client C1 and to device D1. See operation 462. The connection information may include, but is not limited to: session keys, IP addresses, ports, etc.

Step 8: Once client C1 and device D1 receive connection information from YS1 they may communicate as if they had established communication directly between themselves. See operation 464.

Note that other mappings (e.g. static, dynamic, configurable, etc.) are also possible. For example, in one embodiment, a first address A1 (e.g. 127.0.0.2) could be setup to always map to a particular device D1. In one embodiment, a first address A1 (e.g. 127.0.0.2) could be setup to always map to a specific port P1 (e.g. 127.0.0.2:999). Of course the connection(s) (e.g. mapping, etc.) and/or connection type(s) (e.g. address, port, etc.) may also be programmed, programmable, configurable, under software control, etc. For example, in one embodiment, the act of trying to connect to 127.0.0.2:999 may automatically setup (e.g. in the background, trigger, initiate, establish, etc.) the connection as described above. For example, in one embodiment, running one or more virtual proxies may setup one or more connections. In one embodiment, the connections may be kept alive (e.g. using keep alive or other well known technique(s), etc.) so as to have these connections always in place. Of course the connections may be programmable and/or configurable. The connections may be permanent (e.g. fixed, kept alive, etc.) or dynamic (e.g. transient, temporary, configurable, with timeout, etc.).

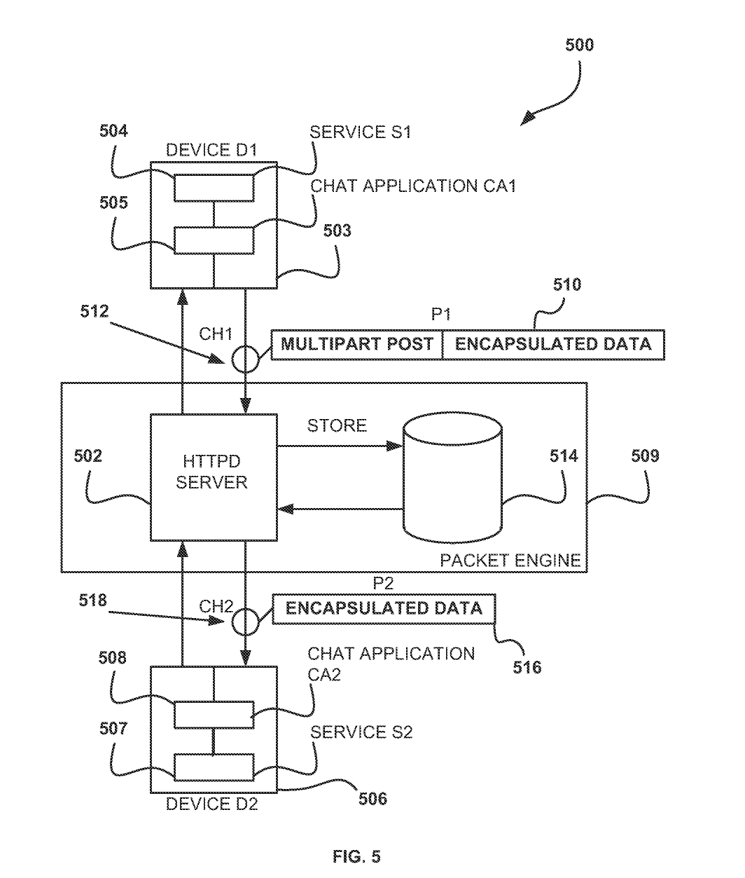

### FIG. 5 HTTP Packet Engine

FIG. 5 shows a computer system 500 including an HTTP packet engine, in accordance with one embodiment. As an option, the computer system 500 may be implemented in the context of any other Figure(s) or accompanying description(s). Of course, however, the computer system 500 may be implemented in the context of any desired environment.

A Hypertext Transfer Protocol Daemon (HTTPD) server is typically a web server (e.g. Apache HTTP server, etc.). A web server delivers web pages on request to clients.

A POST request method (also just POST) is an HTTP method. A POST is used when a client needs to send data to a web server as part of the request (e.g. uploading a file, submitting a completed form, etc.). A POST contains URL, headers, and a message body containing the data to be sent. The POST method from the HTTP standard is defined in section 8.3 of RFC1945 and redefined for HTTP 1.1 in section 9.5 of RFC2616.

A multipart POST may contain multiple parts and uses a different request body format from a POST. The multipart/form-data MIME type used to format the body of a multipart request is defined in RFC1867. The media-type multipart/form-data follows the rules of all multipart MIME data streams as outlined in RFC 1521.

In FIG. 5, an HTTPD server (web server) 502 may be connected to devices 503 and 506. The device 503 may contain a service 504 and a chat application 505. The device 506 may contain a service 507 and a chat application 508.

In FIG. 5, the HTTPD web server 502 may be part of a packet engine 509.

In FIG. 5, the device 503 and the device 506 may communicate using the following (but not limited to the following) steps:

The device 503 may use a POST 510 to send data to the HTTPD web server 502 via a communication channel 512. The device 503 may be a camera for example. The communication channel 512 may be an Ethernet TCP/IP connection for example. The POST 510 may be one or more TCP packets.

The HTTPD web server 502 may optionally store POST 510 to a storage system 514

The packet engine 509 may optionally process POST 510.

The packet engine 509 may forward data 516 to a device 506 using a communication channel 518. Data 516 may be a POST including data from POST 510. The device 506 may be a cell phone for example. The communication channel 518 may be a wireless TCP/IP connection for example. The data 516 may be one or more TCP packets.

In FIG. 5, the device 503 and the device 506 may communicate via the HTTPD web server 502 using multipart POSTs with each POST containing encapsulated data. The HTTPD web server 502 thus acts as an HTTP packet engine.

In one embodiment, the encapsulated data may be multiple packets or parts of packets (e.g. groups of packets, string of packets, etc.). An example multipart POST containing two packets as encapsulated data may be as follows:

POST /path/to/script.php HTTP/1.0
Host: example.com
Content-type: multipart/form-data, boundary=xxxx
--xxxx
content-disposition: form-data; name=“packet1”
<packet1 goes here>
--xxxx
content-disposition: form-data; name=“packet2”
<packet2 goes here>
-xxxx

In one embodiment, the encapsulated data may be any information (e.g. binary data, text data, encrypted data, packets, images, files, video data, other media, commands, credentials, combinations of any of these, etc.).

In one embodiment, any command (e.g. method, protocol, etc.) may be used to transfer encapsulated data (e.g. packets, information, files, media, etc.) from a device 503 to an HTTPD web server 502 via a communication channel 512.

In one embodiment, any command (e.g. method, protocol, etc.) may be used to transfer encapsulated data 516 (e.g. packets, information, files, media, etc.) from an HTTPD web server 502 to a device 506.

In one embodiment, the packet format of the encapsulated data 516 may be TCP, UDP, or any other packet, data stream format, or combination(s) of formats, etc.

In one embodiment, the HTTP packet engine 509 may maintain a routing map (e.g. routing table, etc.).

In one embodiment, the encapsulated data 516 may be used in conjunction with one or more routing maps.

In one embodiment, one or more communication channels (as shown for example in FIG. 5, communication channel 512 and communication channel 518) may use secure methods (e.g. https connections, encrypted data, IPsec, etc.).

In one embodiment, an HTTP packet engine 509 may be used to obscure (e.g. hide, mask, etc.) one or more endpoints.

In one embodiment, multiple HTTP packet engines may be connected in series (e.g. cascade(s), chain(s), etc.).

In one embodiment, one or more HTTP packet engines connected in parallel (e.g. multi-path, etc.) may be used (e.g. for improved reliability, to allow for failover, include redundancy, etc.).

In one embodiment, one or more HTTP packet engines may be used to translate one or more protocols.

In one embodiment, a device 503 and a device 506 may be any devices.

In one embodiment, a device 503 and/or a device 506 may be a client.

In HTTP 1.0, a connection is closed after a single request/response pair. HTTP 1.1 allows a connection to be reused for more than one request. Under HTTP 1.0, there is no official specification for how keepalive operates. If a client (e.g. browser) supports keepalive, the client adds a keepalive header to a request: When the server receives this request and generates a response, the server adds a keepalive header to the response: The connection is kept open. When the client sends another request, it uses the same connection. This process continues until either the client or the server drops the connection. In HTTP 1.1 all connections are considered persistent unless declared otherwise. HTTP persistent connections do not use separate keepalive messages; they allow multiple requests to use a single connection.

TCP keepalives are optional feature. The keepalive packet contains null data. In an Ethernet network, a keepalive frame length is 60 bytes, and the acknowledgement frame length with null data is 54 bytes.

In one embodiment the communication channel(s) may use any communication mechanism (e.g. HTTP POST, HTTP PUT, HTTP keepalive, TCP keepalive, combinations of these, etc.) in either a standard or non-standard manner. For example one or more null data fields in standard packet format(s) may be used to convey (e.g. communicate, transfer, etc.) or store (e.g. keep state, etc.) information (e.g. data, state, credentials, etc.) in a non-standard manner, etc.

In one embodiment, HTTP PUT may be used to send packets to the HTTP packet engine. For example, packets may be sent unencoded, with a length, in raw format, etc. For example, using keepalive HTTP PUT may be an efficient way to send data via HTTP.

In one embodiment, the HTTP engine may support multipart POST and PUT.

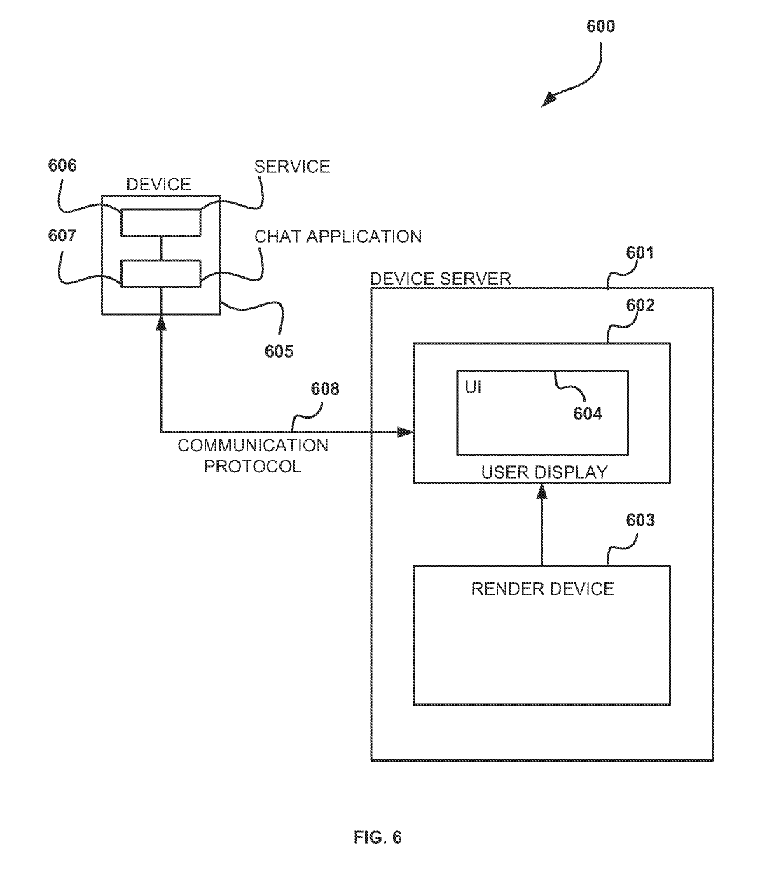

### FIG. 6 Abstract User Interface

FIG. 6 shows a system 600 comprising an abstract user interface to communicate to a device, in accordance with one embodiment. As an option, the system 600 may be implemented in the context of any other Figure(s) or accompanying description(s). Of course, however, the system 600 may be implemented in the context of any desired environment.

In FIG. 6, a device server 601 may contain a user display 602 and a render device 603.

In FIG. 6, the user display 602 may contain a user interface 604.

In FIG. 6, the render device 603 may be connected to the user display 604,

In FIG. 6, the device 605 may be coupled to the user display 604 via a communication protocol 606.

In FIG. 6, a device 605 may not have the CPU power to run its own user interface (e.g. UI, GUI, etc.). Examples of a device 605 may include a camera, sprinkler system, thermostat, etc. To establish communication with such a device 605, an abstract user interface (AUI) is created

In one embodiment, an AUI may be separate from the device 605.

In one embodiment, an AUI may be different for different users, devices, etc.

For example, a device 605 may be a thermostat.

For example, a user display 602 may display a user interface 604.

For example, a render device, 603 may drive user display 602.

For example, a device server 601 communicates with user device 605 using a communication protocol 606.

For example, the thermostat is coupled to user display 602 via the communication protocol 606.

In one embodiment the user interface 604 includes user display 602.

In one embodiment, the user display 602 includes the user interface 604.

In one embodiment, two or more device servers, each with displays, communicate with a device 605. Each user interface may be different.

In one embodiment, a device server 601 may be a web server, data server, control server, with/without user interaction.

For example, a device server 601 may be an Apache web server, but could also be a stand-alone application, etc. running on a CPU.

In one embodiment, a device server 601 may be a separate hardware system.

In one embodiment, a render device 603 may be a visual display unit (VDU). For example, a render device 603 may be a LCD screen, a CRT, a remote control, any form of hardware, or may be one or more lights (e.g. LEDs, bulbs, displays, dials, etc.), may be one or more audio alarms etc, may be one or more control panels etc.

In one embodiment, a user interface 604 may be a GUI on a user display 602 (for example, a touchscreen, etc.).

In one embodiment, a user display 602 may be part of a user interface 604 (e.g. a control panel that includes one or more buttons, switches, etc. as well as one or more LCD screens etc.).

In one embodiment, a different user interface 604 may be used for different web servers, different user devices, different functions, different users, different uses, different places, different virtual devices, different contract rates, premium services, etc.

In one embodiment, a communication protocol 606 may be any type of protocol that may or may not contain methods, commands etc.

In one embodiment, a communication protocol 606 may be any a set of procedures to be followed when communicating.

In one embodiment, a communication protocol 606 may be a standard protocol or non-standard protocol.

In one embodiment, a communication protocol 606 may be equivalent to a standard protocol. May be one or more subsets of one or more standard protocols (e.g. one or more subsets of one or more command sets of one or more standard protocols, etc.).

In one embodiment, a communication protocol 606 may be a superset of one or more standard protocols i.e. one or more standard protocols with the addition of one or more non-standard commands (e.g. methods, etc.).

In one embodiment, a communication protocol 606 may be a combination of any of the above (e.g. a combination of a non-standard protocol with a standard protocol, a combination of one or more protocol subsets with one or more protocol supersets, etc.).

In one embodiment, a communication protocol 606 may be any type or combinations of types of services (e.g. Internet services, application layer protocols, other service types, etc.). Examples of standard services include, but are not limited to, the following: echo, daytime, ftp, smtp, time, whois, nameserver, bootp, tftp, gopher, finger, http, pop, pop2, pop3, portmap, path, exec, login, who, timed, kerberos, man, nfs, irc, etc.

In one embodiment, a communication protocol 606 may be any type or combinations of types of standard Internet protocols (e.g. UDP, TCP, ARP, RARP, CDP, PPTP, L2TP, SLIP, ATM, IPv4, IPv6, EGP, ICMP, IGMP, AppleTalk, OSPF, BGP, ICMP, AH, ESP, IPsec, SCTP, NFS, SMB, RADIUS, MIME, IMAP, IRC, NTP, RDP, RTP, SIP, SMTP, SOAP, SMB, TFTP, WebDAV, etc.).

In one embodiment, a communication protocol 606 may perform the equivalent of any methods (also verbs, actions, etc.) or combinations of methods of any standard or non-standard protocol. For example, communication protocol 606 may perform the equivalent of HTTP GET and/or HTTP POST and/or HTTP PUT and/or other similar methods etc. driven by a web server running on a device server 601.

In one embodiment, a communication protocol 606 may be a suite (e.g. one or more, family, multi-layer, group, collection, etc.) of protocols.

In one embodiment, a communication protocol 606 may contain one or more of the following layers or their equivalents and/or other layer(s) and/or equivalent(s): application layer; presentation layer; session layer; transport layer; network layer (data and/or management); data link layer; physical layer.

In one embodiment, a communication protocol 606 may vary between users, user devices, device servers, etc.

In one embodiment, a communication protocol 606 (or portions of communication protocol 606, etc.) may be secure or non-secure.

In one embodiment, a communication protocol 606 may perform one or more of the following: data format(s) for data exchange; address format(s) for data exchange; address mapping; routing; detection and/or correction of transmission errors; acknowledgment(s) of reception; timeout; retransmission; media access control (e.g. transmit direction control etc.); sequence control (e.g. reordering, etc.); flow control (e.g. transmission rate, etc.); etc.

In one embodiment, a communication protocol 606 may use any format of transmission (e.g. simplex, multiplexed, time-multiplexed, half-duplex, full-duplex, packets, datagrams, bit streams, etc.).

In one embodiment, a communication protocol 606 may use any form of media (e.g. wired, wireless, optical, magnetic, etc.).

In one embodiment, a communication protocol 606 may use any type of connection (e.g. a connectionless network, a connection oriented network, etc.).

In one embodiment, a state (e.g. device state, user state, user credentials and/or other information, service information, HTTP cookies, etc.) may or may not be stored on web server/render device/user device.

In one embodiment, a communication protocol 606 may be established via localhost, i.e. http://localhost.

In one embodiment, a communication protocol 606 may be established via IP address, i.e. http://172.16.254.1.

In one embodiment, a communication protocol 606 may be established via ports, i.e. http://172.16.254.1:80.

In one embodiment, a communication protocol 606 may be established via a combination of localhost, IP address, ports, etc.

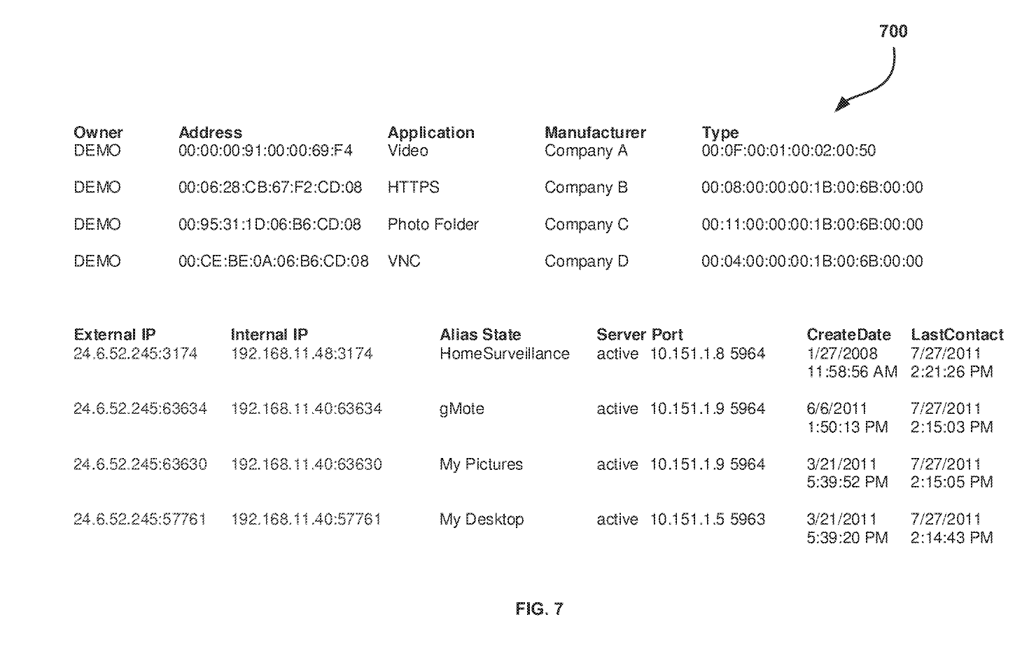

### FIG. 7 Master Database

FIG. 7 shows the content of a computer program 700 comprising a master database, in accordance with one embodiment. As an option, the database may be implemented in the context of any other Figure(s) or accompanying description(s). Of course, however, the database may be implemented in the context of any desired environment.

In FIG. 7, the master database 700 may contain (but is not limited to) the following fields: Owner, Address, Application, Manufacturer, Type, External IP, Internal IP, Alias, State, Server, Port, CreateDate, LastContact.

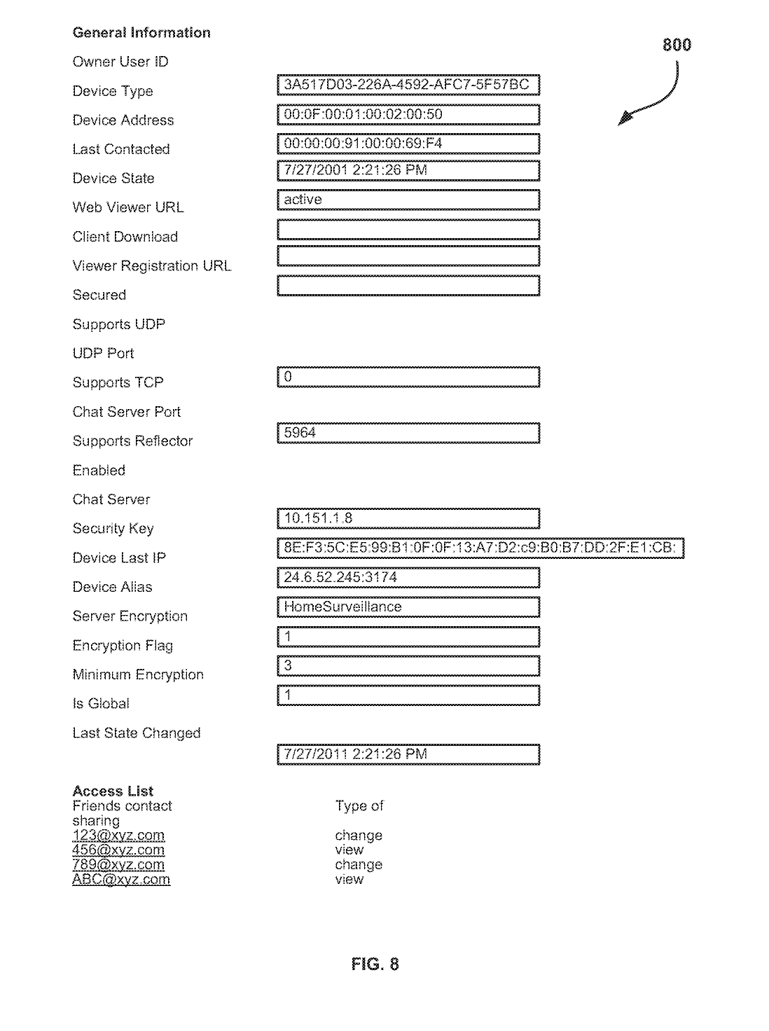

### FIG. 8 Computer Program Containing Service Information

FIG. 8 shows the contents of a computer program 800 containing device information, in accordance with one embodiment. As an option, the computer program 800 may be implemented in the context of any other Figure(s) or accompanying description(s). Of course, however, the computer program 800 may be implemented in the context of any desired environment.

In FIG. 8, the computer program 800 containing device information may contain (but is not limited to) the following fields: Owner User ID, Device Type, Device Address, Last Contacted, Device State, Web Viewer URL, Client Download, Viewer Registration URL, Secured, Supports UDP, UDP Port, Supports TCP, Chat Server Port, Supports Reflector, Enabled, Chat Server, Security Key, Device Last IP, Device Alias, Server Encryption, Encryption Flag, Minimum Encryption, Global, Last State Changed, Access List, Recent Sessions, etc. Of course in other embodiments fewer fields may be used, or more fields may be used containing similar information, etc.

1. A computer program product embodied on a non-transitory computer readable medium, comprising:
code for receiving communications utilizing an IP protocol that are directed to at least one module including a first function;
code for intercepting the communications; and
code for modifying or creating at least one aspect of the communications for emulating a second function that is different from the first function of the at least one module.

2. The computer program product of claim 1, wherein the computer program product includes at least one abstraction layer in communication with the at least one module.

3. The computer program product of claim 1, wherein the at least one module includes a hardware module.

4. The computer program product of claim 1, wherein the at least one module includes a software module.

5. The computer program product of claim 1, wherein the code includes hardware code.

6. The computer program product of claim 1, wherein the code includes software code.

7. The computer program product of claim 1, wherein the computer program product is operable such that the communications are intercepted after the communications are communicated utilizing the IP protocol.

8. The computer program product of claim 1, wherein the computer program product is operable such that the communications are intercepted during the communication of the communications utilizing the IP protocol.

9. The computer program product of claim 1, wherein the computer program product is operable such that the modifying or creating includes modifying.

10. The computer program product of claim 1, wherein the computer program product is operable such that the modifying or creating includes creating.

11. The computer program product of claim 1, wherein the at least one module includes a software service or device associated with a client.

12. The computer program product of claim 1, wherein the at least one module includes a software service or device associated with a router.

13. The computer program product of claim 1, wherein the at least one module includes a software service or device associated with a server.

14. The computer program product of claim 1, wherein the at least one module includes a software service or device associated with a web server.

15. The computer program product of claim 1, wherein the at least one module includes a software service or device associated with a reverse proxy server.

16. The computer program product of claim 1, wherein the at least one aspect of the communications includes a level of security.

17. The computer program product of claim 1, wherein the first function involves a first type of connection and the second function that is emulated involves a second type of connection.

18. The computer program product of claim 1, wherein the first function involves a less-secure connection and the second function that is emulated involves a more-secure connection.

19. The computer program product of claim 1, wherein the at least one aspect of the communications includes a proxy name.

20. The computer program product of claim 1, wherein the at least one aspect of the communications includes a local host name.

21. The computer program product of claim 1, wherein the first function involves a first proxy name and the second function involves a second proxy name.

22. The computer program product of claim 1, wherein the computer program product is operable such that the modifying or creating of the at least one aspect of the communications includes creating at least one virtual device.

23. The computer program product of claim 1, wherein the first function involves a physical device without a virtual device and the second function involves at least one virtual device in association with the physical device.

24. The computer program product of claim 1, wherein the first function involves a physical device without a virtual device and the second function involves a plurality of virtual devices in association with the physical device.

25. The computer program product of claim 1, wherein the at least one aspect of the communications includes a number of endpoints.

26. The computer program product of claim 1, wherein the first function involves an n-way communication and the second function that is emulated involves an m-way communication.

27. The computer program product of claim 1, wherein the first function involves a 3-way communication and the second function that is emulated involves a 2-way communication.

28. The computer program product of claim 1, wherein the first function involves a first communication protocol and the second function involves a second communication protocol.

29. The computer program product of claim 1, wherein the computer program product is operable such that the modifying or creating of the at least one aspect of the communications includes creating at least one user interface.

30. The computer program product of claim 1, wherein the computer program product is operable such that the modifying or creating of the at least one aspect of the communications includes modifying at least one user interface.

31. The computer program product of claim 1, wherein the first function involves a first user interface and a second function involves a second user interface.

32. A method, comprising:
receiving communications utilizing an IP protocol that are directed to at least one module including a first function;
intercepting the communications; and
modifying or creating at least one aspect of the communications for emulating a second function that is different from the first function of the at least one module.

33. An apparatus, comprising:
circuitry for receiving communications utilizing an IP protocol that are directed to at least one module including a first function;
circuitry for intercepting the communications; and
circuitry for modifying or creating at least one aspect of the communications for emulating a second function that is different from the first function of the at least one module.
